(19) United States
(12) Patent Application Publication
(10) Pub. No.: US 2015/0163391 A1
(43) Pub. Date: Jun. 11, 2015

(54) IMAGE CAPTURING APPARATUS, CONTROL METHOD OF IMAGE CAPTURING APPARATUS, AND NON-TRANSITORY COMPUTER READABLE STORAGE MEDIUM

(71) Applicant: CANON KABUSHIKI KAISHA, Tokyo (JP)

(72) Inventor: Shinnosuke Osawa, Tokyo (JP)

(21) Appl. No.: 14/563,640

(22) Filed: Dec. 8, 2014

(30) Foreign Application Priority Data
Dec. 10, 2013 (JP) 2013-255373

(51) Int. Cl. H04N 5/235; H04N 5/232; G06K 9/46; G06T 7/00; G06K 9/48

(52) U.S. Cl. CPC H04N 5/2353; G06T 7/00; G06K 9/48; G06K 9/46; H04N 5/23212; G06K 2009/4666

(57) ABSTRACT

An image capturing apparatus analyzes an image shot by a shooting unit and processes the image based on an analysis result. The apparatus analyzes a standby image generated during shooting standby before an instruction of shooting to detect an object from the standby image, and performs bracket shooting for the detected object using a shooting condition set for each object in accordance with the instruction of shooting. The apparatus also analyzes a plurality of bracket images to detect an object region including the object from each of the plurality of bracket images, to perform determination for each detected object region in association with the shooting condition, and to select at least one bracket image out of the plurality of bracket images for each object region according to the determination result. The apparatus executes image processing on the selected bracket image for each object region.

### BACKGROUND OF THE INVENTION

1. Field of the Invention

The present invention relates to an image capturing apparatus, a control method of the image capturing apparatus, and a non-transitory computer readable storage medium.

2. Description of the Related Art

There are known an AE bracket function of performing bracket shooting using a plurality of exposure values and an AF bracket function of performing bracket shooting at a plurality of focus positions. Japanese Patent Laid-Open No. 2012-119788 discloses a technique of performing AE bracket shooting by analyzing the scene of a live view image during shooting standby, deciding a plurality of target objects to adjust exposure, and setting a plurality of exposure values according to the target objects.

There is also generally known a technique of generating images of different tastes by performing image processing such as blur processing, color filter processing, and trimming processing.

Assume an arrangement for performing, for each image shot by bracketing, image processing according to an object in the combining of the above-described techniques. In this case, if the techniques are only simply combined, the following problem arises. For example, according to Japanese Patent Laid-Open No. 2012-119788, shooting is performed by obtaining exposure values for bracketing based on object information of a plurality of faces and the like detected during shooting standby. At this time, if the position or brightness of an object changes during a time from the shooting standby to actual shooting, a bracket image with exposure adjusted for the object during shooting standby is not appropriate for the object. For this reason, when an image is generated from the bracket image by performing image processing based on the object information, for example, an image extracted at a position shifted from the object under inappropriate exposure may be generated.

### SUMMARY OF THE INVENTION

The present invention makes it possible to generate a more appropriate image when performing image processing according to an object for a bracket image.

One aspect of embodiments of the present invention relates to an image capturing apparatus comprising, a shooting unit, an analysis unit configured to analyze an image shot by the shooting unit, and an image processing unit configured to process the image based on an analysis result of the analysis unit, wherein the analysis unit is further configured to analyze a standby image generated by the shooting unit during shooting standby before an instruction of shooting to detect an object from the standby image, and the shooting unit is configured to perform bracket shooting for the detected object using a shooting condition set for each object in accordance with the instruction of shooting, the analysis unit is further configured to analyze a plurality of bracket images generated by the bracket shooting, to detect an object region including the object from each of the plurality of bracket images, to perform determination for each detected object region in association with the shooting condition, and to select at least one bracket image out of the plurality of bracket images for each object region in accordance with a result of the determination, and the image processing unit is further configured to execute image processing on the selected bracket image for each object region.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention, and together with the description, serve to explain the principles of the invention.

FIG. 1 is a block diagram showing an example of the arrangement of an image capturing apparatus according to an embodiment of the present invention;

FIG. 2 is a flowchart showing an example of shooting processing according to the embodiment of the present invention;

FIG. 3 is a flowchart showing an example of scene analysis processing according to the embodiment of the present invention;

FIG. 4 is a view for explaining an example of shooting processing according to the embodiment of the present invention;

FIGS. 5A and 5B are views for explaining an example of scene analysis result integration according to the embodiment of the present invention;

FIG. 6 is a flowchart showing an example of a method of image processing for each shot image according to the embodiment of the present invention; and

FIG. 7 is a view showing an example of the result of trimming processing according to the embodiment of the present invention.

### DESCRIPTION OF THE EMBODIMENTS

The embodiment of the present invention will now be described in detail with reference to the accompanying drawings. A so-called digital camera will be exemplified here as an image capturing apparatus, an information processing apparatus, or an image processing apparatus according to the embodiment of the present invention. However, the present invention is not limited to this. The present invention may be implemented as any other apparatus having a shooting function, for example, a digital video camera, a portable phone, a smartphone, or another portable electronic device.

### First Embodiment

<Arrangement of Digital Camera>

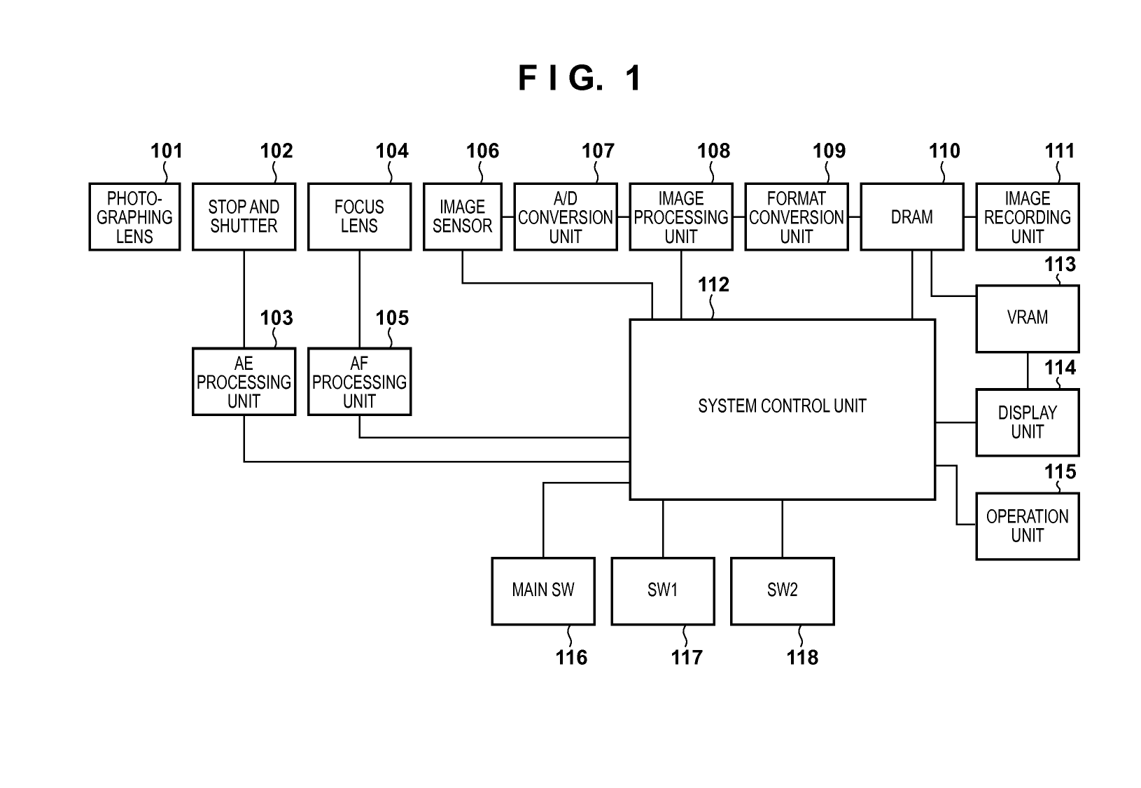

FIG. 1 is a block diagram showing the arrangement of a digital camera according to the embodiment of the present invention. FIG. 1 illustrates the hardware arrangement of a digital camera 100. However, the arrangement illustrated here is merely an example, and constituent elements other than those shown in FIG. 1 may be added. In the digital camera 100 shown in FIG. 1, the blocks may be constructed as hardware using a dedicated logic circuit or memory except physical devices such as an image sensor, a display unit, an operation unit, and switches. Alternatively, the blocks may be constructed as software by causing a computer such as a CPU to execute a processing program stored in a memory. The constituent elements of the digital camera 100 and their functions will be described below.

A photographing lens 101 includes a zoom mechanism. A stop and shutter 102 controls the amount of incident light, which is reflected light from an object, to an image sensor 106 and a charge accumulation time in accordance with an instruction from an AE processing unit 103. The AE processing unit 103 controls the operation of the stop and shutter 102 and also controls an A/D conversion unit 107 to be described later. A focus lens 104 sets the light-receiving surface of the image sensor 106 into focus and forms an optical image in accordance with a control signal from an AF processing unit 105.

The image sensor 106 converts the optical image formed on the light-receiving surface into an electrical signal by a photoelectric conversion device such as a CCD sensor or a CMOS sensor, and outputs the signal to the A/D conversion unit 107. The A/D conversion unit 107 converts the received electrical signal (analog signal) into a digital signal. The A/D conversion unit 107 includes a CDS circuit that removes noise from the received electrical signal and a nonlinear amplification circuit that nonlinearly amplifies the received electrical signal before conversion to a digital signal.

An image processing unit 108 performs resize processing such as predetermined pixel interpolation or image reduction and color conversion processing on the digital signal output from the A/D conversion unit 107, and outputs image data. A format conversion unit 109 performs format conversion of the image data generated by the image processing unit 108 to store the image data in a DRAM 110. The DRAM 110 is an example of a high-speed internal memory and is used as a high-speed buffer for temporarily storing image data or a working memory in image data compression/decompression processing.

An image recording unit 111 includes a recording medium such as a memory card that records a shot image (still image or moving image) and an interface thereof. A system control unit 112 includes a CPU, a ROM, and a RAM, and controls the overall operation of the digital camera by causing the CPU to load a program stored in the ROM to the work area of the RAM and execute it. The system control unit 112 also controls to decide which mode is to be used out of a plurality of shooting drive modes of the image sensor 106. A VRAM 113 is a memory for image display. A display unit 114 is, for example, an LCD and performs image display, display for operation aid, or display of a camera state. Upon shooting, the display unit 114 displays a shooting screen and a distance measuring area.

The user operates an operation unit 115, thereby externally operating the digital camera. The operation unit 115 includes, for example, a menu switch that performs various settings such as settings of exposure correction and f-number and settings for image reproduction, a zoom lever that instructs the zoom operation of the photographing lens, and an operation mode selector switch between a shooting mode and a reproduction mode. A main switch 116 is a switch used to power on the system of the digital camera. A first switch 117 is a switch used to do a preshooting operation such as AE processing or AF processing. The preshooting operation such as AE processing or AF processing performed by operating the first switch (SW1) will be referred to as SW1 processing hereinafter. A second switch 118 is a switch used to input a shooting instruction to the system control unit 112 after the operation of the first switch 117. The shooting instruction processing performed by operating the second switch (SW2) will be referred to as SW2 processing hereinafter. Note that SW1 and SW2 may be implemented as a single shutter button. For example, when the shutter button is pressed halfway, SW1 is operated. When the shutter button is pressed fully, SW2 is operated.

<Overall Flowchart>

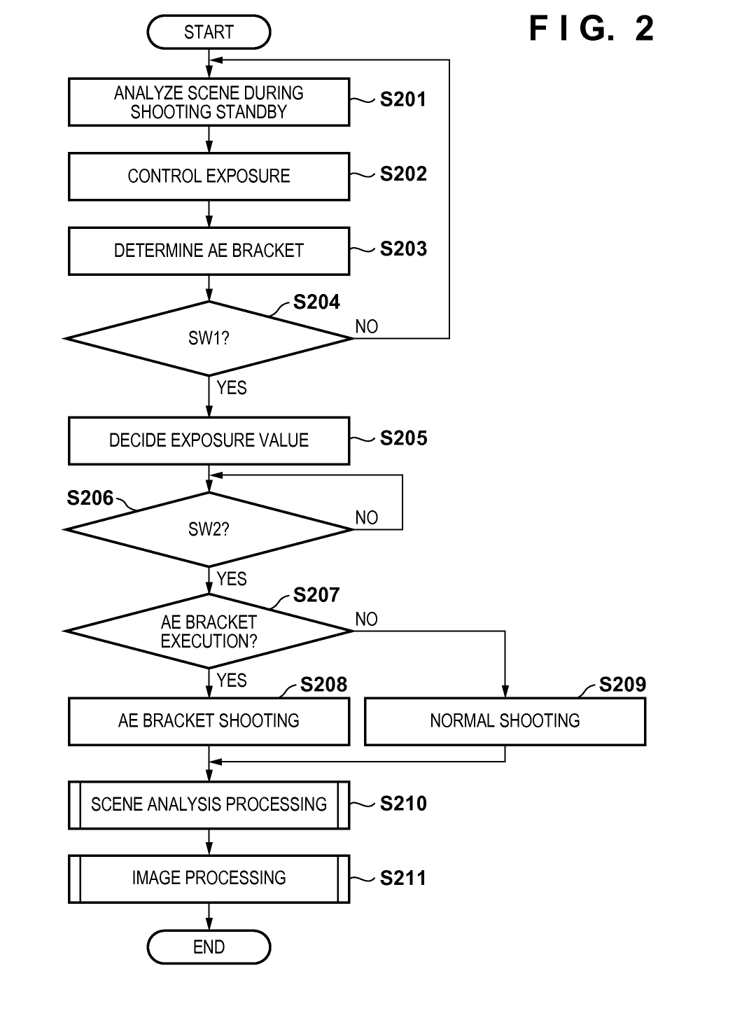

The flow of processing in the digital camera 100 according to the embodiment of the present invention will be described next with reference to FIG. 2. In this embodiment, a method of performing AE bracket processing and then image processing will be exemplified. FIG. 2 is a flowchart showing an example of the method of performing AE bracket processing and image processing. Processing corresponding to the flowchart can be implemented by, for example, causing the CPU to load a corresponding program stored in the ROM to the work area of the RAM and execute it in the system control unit 112.

In step S201, the scene of a live view image during shooting standby is analyzed. For example, a feature region detection technique of detecting a blue sky region in an image or an object detection technique of detecting a human face or the like is used here. This result will be referred to as a scene analysis result. Various known methods are usable for this. Note that the live view image is an image shot by the image sensor and displayed on the display unit 114 without the shooting instruction of the SW2.

In step S202, exposure control is performed. Based on the scene analysis result of step S201 and the like, the exposure control is done in consideration of the balance of the entire scene preferable for the live view image during shooting standby. For example, a known exposure control method such as an evaluation metering method of metering light by obtaining an average luminance in a wide range of the screen using a template weight with a weight for each photometric area may be used.

In step S203, it is determined whether to perform AE bracket shooting. An object (AE bracket target object) as the target of AE bracket may be decided based on the scene analysis result of step S201, and the AE bracket determination may be done based on the luminance value of the AE bracket target object region. When a plurality of objects or feature regions which suffer underexposure or overexposure exist in the live view image, it is determined to perform AE bracket shooting. At this time, the number of times of bracket shooting to be performed is set as many as the number of AE bracket target objects.

In step S204, it is determined whether SW1 processing is performed. If SW1 processing is performed (“YES” in step S204), the process advances to step S205. Otherwise (“NO” in step S204), the process returns to step S201, and the processes of steps S201 to S204 are periodically repeated. In step S205, upon determining in step S203 to perform AE bracket, the exposure value is decided for each bracket process based on the luminance value of the AE bracket target object. Upon determining not to perform AE bracket, the exposure value for one shooting process is decided. For example, the method of Japanese Patent Laid-Open No. 2012-119788 is usable.

In step S206, it is determined whether SW2 processing is performed. If SW2 processing is performed (“YES” in step S206), the process advances to step S207. In step S207, it is determined whether the AE bracket determination has been done in step S203. Upon determining to perform AE bracket, the process advances to step S208. Upon determining not to perform AE bracket, the process advances to step S209. In step S208, AE bracket shooting is performed based on the exposure value decided in step S205. Each shot image is stored in association with a corresponding AE bracket target object.

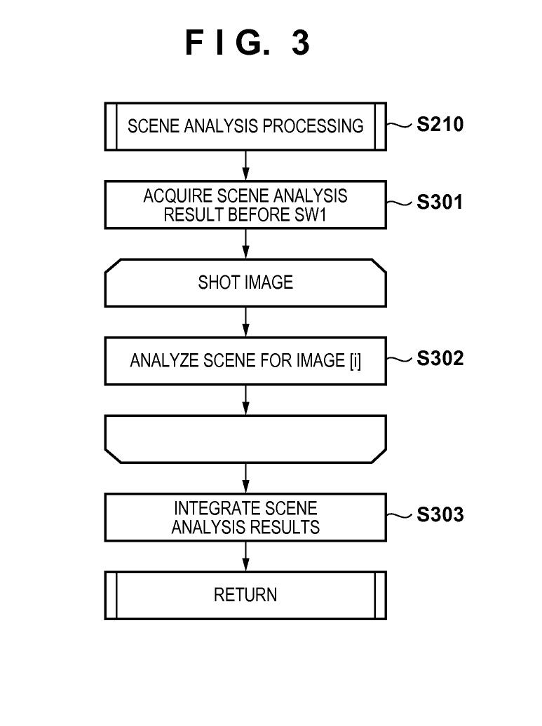

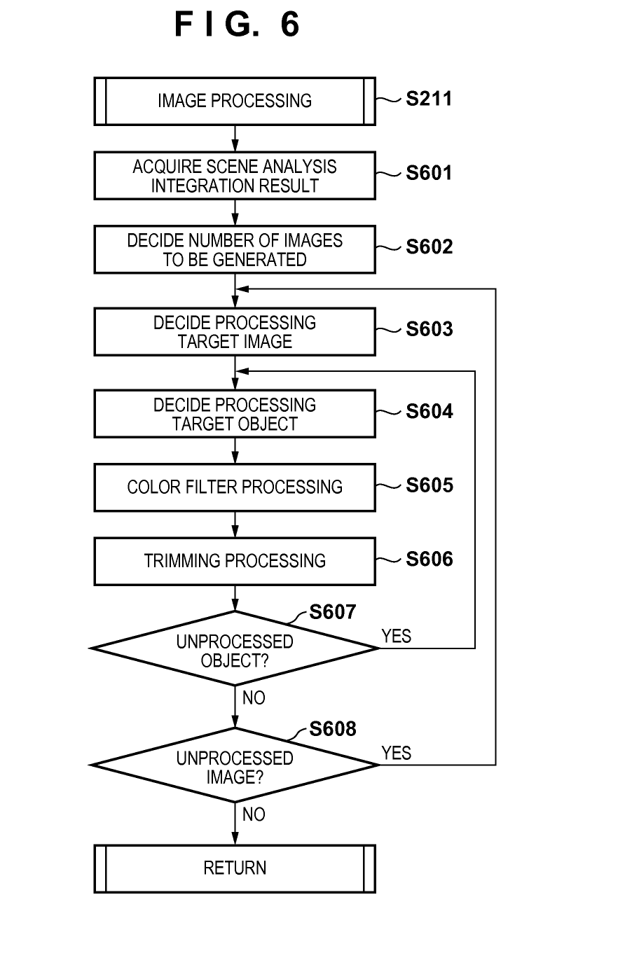

In step S209, normal shooting is performed. In the normal shooting as well, the shot image is stored in association with the object to which the exposure is adjusted at the time of shooting. In step S210, scene analysis is performed using the images shot in step S208 or S209. The scene analysis method will be described with reference to FIG. 3. In step S211, image processing is performed for each image based on the scene analysis result using the shot image of step S210. The image processing method will be described with reference to FIG. 6.

<Scene Analysis Using Shot Images>

A scene analysis method using shot images will be described next. FIG. 3 is a flowchart showing an example of processing of performing scene analysis using shot images. Processing corresponding to this flowchart can also be implemented by, for example, causing the CPU to load a corresponding program stored in the ROM to the work area of the RAM and execute it in the system control unit 112.

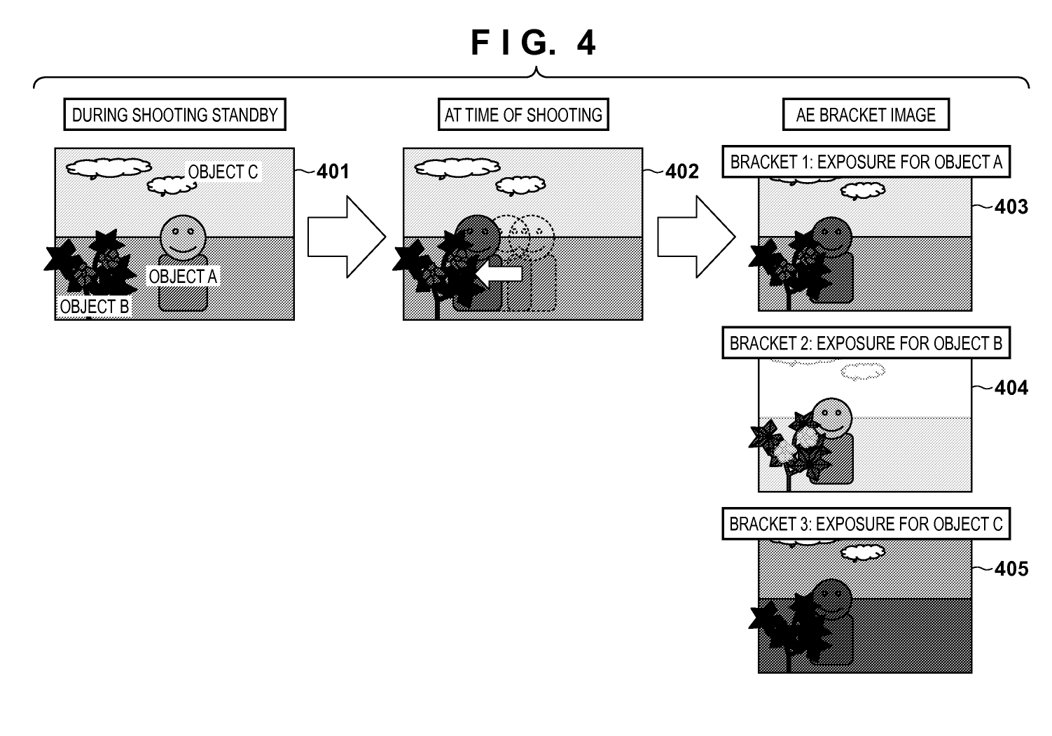

FIG. 4 shows an example of an AE bracket image acquired based on a live view image obtained by shooting an exemplary scene according to this embodiment. In FIG. 4, an image 401 acquired during shooting standby includes a person as an object A, a plant as an object B, and clouds as an object C. The flow of scene analysis processing will be described using the image 401 as an example.

In step S301, the scene analysis result during shooting standby in step S201 of FIG. 2 is acquired. During shooting standby of the standby image 401 in FIG. 4, for example, the person as the object A exists in the central region of the image with a medium luminance. In step S302, scene analysis is performed for each image obtained by bracket shooting using loop processing. For the scene analysis processing, the same known method as in step S201 of FIG. 2 can be used. The processing is performed sequentially from the first shot image. When the processing has ended for all shot images, the process exits from the loop and advances to step S303. In the example of FIG. 4, the three objects and feature regions are determined to be AE bracket target objects in step S203. Hence, an exposure value corresponding to the object A (person) is set for the first shot image, an exposure value corresponding to the object B (plant) is set for the second shot image, and an exposure value corresponding to the object C (clouds) is set for the third shot image. Three bracket images 403 to 405 are shot. Scene analysis is sequentially performed for the three images. After the third bracket image is performed, the process exits from the loop.

In step S303, the analysis result of the shooting standby scene acquired in step S301 and the scene analysis results using the shot images acquired in step S302 are integrated. First, for each of the scene analysis result during shooting standby and the scene analysis results using the shot images, a list of the positions, sizes, luminance values, and the like of the objects is created. It is determined next whether each object detected by the scene analysis processing of the shooting standby image 401 matches an object detected by scene analysis processing using the bracket images 403 to 405 obtained by bracket shooting. The matching determination may be done according to whether, for example, the difference between the object sizes or positions falls within a predetermined range. When the object is a face, matching may be determined using a known face authentication method.

For an object determined to match, the luminance value of the matching object region in the bracket image is measured. An object of interest is selected from the AE bracket target objects, and the luminance value (average luminance value) of the region of the object of interest is compared with a predetermined value (appropriate value: appropriate luminance value CL). A bracket image for which the difference between the luminance value and the appropriate value is minimum, that is, the luminance value is closest to the appropriate value is selected again as an appropriate bracket image corresponding to the object of interest. This processing is executed while setting each AE bracket target object as the object of interest.

It may be determined whether the shooting environment or shooting situation (scene) has changed between bracket images, and upon determining that the scene has changed, a scene analysis integration result may be created. Alternatively, it may be determined whether the shooting environment or shooting situation (scene) has changed between a plurality of images obtained during the time from the final scene analysis before SW1 processing to the end of bracket shooting. As for the scene change determination, for example, when satisfying at least one of the condition that the moving amount of the same object is equal to or larger than a predetermined amount, the condition that the change amount of the angle of view is equal to or larger than a predetermined amount, and the condition that the change amount of the luminance value is equal to or larger than a predetermined amount between images obtained during that time, the scene may be determined to have changed. Note that the condition that the change amount of the luminance value is equal to or larger than a predetermined amount means that, for example, the change amount of the average luminance value of the entire or partial image is larger than a luminance change amount that should be generated by AE bracket. If the scene has not changed during the time from the final scene analysis before SW1 processing to the end of bracket shooting, it is believed that bracket images in which each object of interest has an appropriate value can be obtained based on the scene analysis result obtained during shooting standby. For this reason, scene analysis integration need not be executed. The first image is determined to be an image having an appropriate luminance for the object A, the second image is determined to be an image having an appropriate luminance for the object B, and the third image is determined to be an image having an appropriate luminance for the object C. With this arrangement, since unnecessary scene analysis integration is not performed, an effect of shortening the processing time can be obtained.

Actual processing will be described using FIG. 4 as an example. The object A moves from the center of the screen shown in the shooting standby image 401 to the left of the screen at the time of shooting as shown in the phase diagram indicated by reference numeral 402. For this reason, the luminance value decreases, and the object A has no appropriate luminance anymore. Hence, the first bracket image 403 in which the exposure value corresponding to the object A is set under the condition of shooting standby indicated by the standby image 401 has no appropriate exposure for the object A. However, with the above-described processing, the second bracket image 404 in which the luminance value of the object A is closest to the appropriate value can be selected again as the bracket image corresponding to the object A.

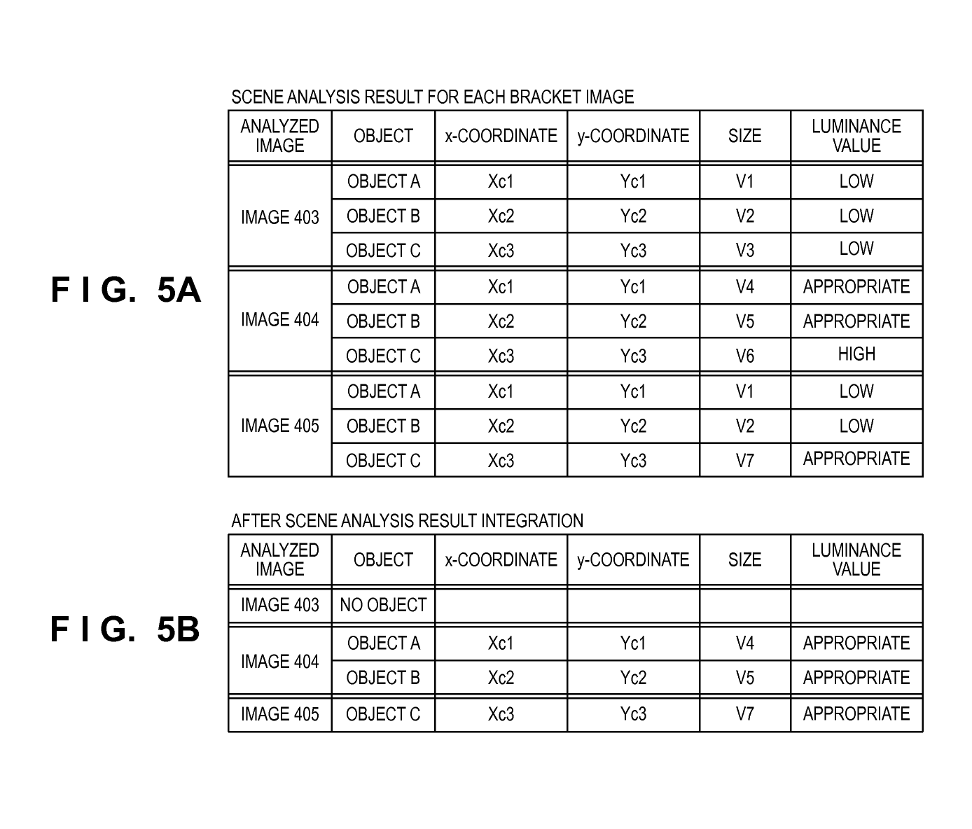

FIGS. 5A and 5B are views showing an example of integration processing of scene analysis results. Referring to FIGS. 5A and 5B, as a scene analysis integration result, a corresponding object and the position, size, luminance value and the like of the object are held on a table for each bracket image. In the table shown in FIG. 5A, data of the objects A to C are registered in correspondence with each of the first to third bracket images 403 to 405. As the luminance values, indices of three levels, low, high, and appropriate are registered based on the result of comparison with the appropriate luminance value. However, actual values may be registered. The registered values may be average luminance values in the object region.

The table shown in FIG. 5B represents data after integration. In this case, the data of objects that overlap between the bracket images are deleted, and one entry is formed in correspondence with one object. All the luminance values of the objects registered in the table of FIG. 5B are “appropriate”. Note that although only one image having an appropriate luminance value exists for each object in FIGS. 5A and 5B, a plurality of images may exist. In this case, an image for which the difference between the luminance value and the appropriate luminance value of an object region is the smallest can be selected.

<Image Processing>

Details of image processing of step S211 in FIG. 2 will be described next with reference to the flowchart of FIG. 6. FIG. 6 is a flowchart showing an example of a method of performing image processing. A method of performing color filter processing and trimming processing as image processing will be exemplified here. However, the processing is not limited to this, and any other known image processing such as blur processing can be performed. Processing corresponding to this flowchart can also be implemented by, for example, causing the CPU to load a corresponding program stored in the ROM to the work area of the RAM and execute it in the system control unit 112.

In step S601, the scene analysis integration result generated in step S303 is acquired. In step S602, the number of images to be generated is decided based on the scene analysis integration result acquired in step S601. The number of images to be generated is decided for each bracket image. For example, no image is to be generated from the image 403, two images are to be generated from the image 404, and one image is to be generated from the image 405. At this time, the number of images to be generated from each bracket image can be decided based on the number of objects registered in the table (FIG. 5B) of the scene analysis integration result.

In step S603, a bracket image that is to undergo subsequent processing is decided. The initial value can be set to the second image 404 because no image is to be generated from the first image 403 in accordance with the decision result of the number of images to be generated in step S303. In step S604, a processing target object is decided. The initial value can be set to the object A in accordance with the scene analysis integration result.

In step S605, color filter processing is executed. In the color filter processing, a filter to be applied may be decided in accordance with the type of object included in the scene analysis integration result. For example, when the object includes a face, a soft focus filter or a filter that provides a high key effect may be applied. A filter for light falloff at edges may be applied not to decrease the luminance value of the face region. For a scenic object such as a flower or a plant, an edge enhancement filter that enhance edges may be applied. For clouds or sky, a low-pass filter may be applied to remove noise.

In step S606, trimming processing is executed. The trimming processing is executed by setting a trimming region based on the position and size of each object included in the scene analysis integration result so that the target object decided in step S603 is arranged at an appropriate position in the trimming image. The appropriate position may be decided based on, for example, a known long-established composition such as the centered composition in which the object is arranged at the center of the image or the rule of thirds in which the object is arranged at an section of lines that divides the image into three parts in the vertical and horizontal directions. At this time, the trimming region may be set while avoiding other object regions based on the position information of each object region included in the scene analysis integration result. When this processing is performed, a satisfactory trimming image can be generated for the scene shown in FIG. 4.

In step S607, it is determined whether there exists an unprocessed object for which an image is to be generated from the processing target bracket image. If an unprocessed object exists (“YES” in step S607), the process returns to step S604 to select the unprocessed object and continue the processing. If no unprocessed object exists (“NO” in step S607), the process advances to step S608 to determine whether there exists an unprocessed bracket image. If an unprocessed bracket image exists (“YES” in step S608), the process returns to step S603 to select the unprocessed bracket image and continue the processing. If no unprocessed bracket image exists (“NO” in step S608), the processing ends.

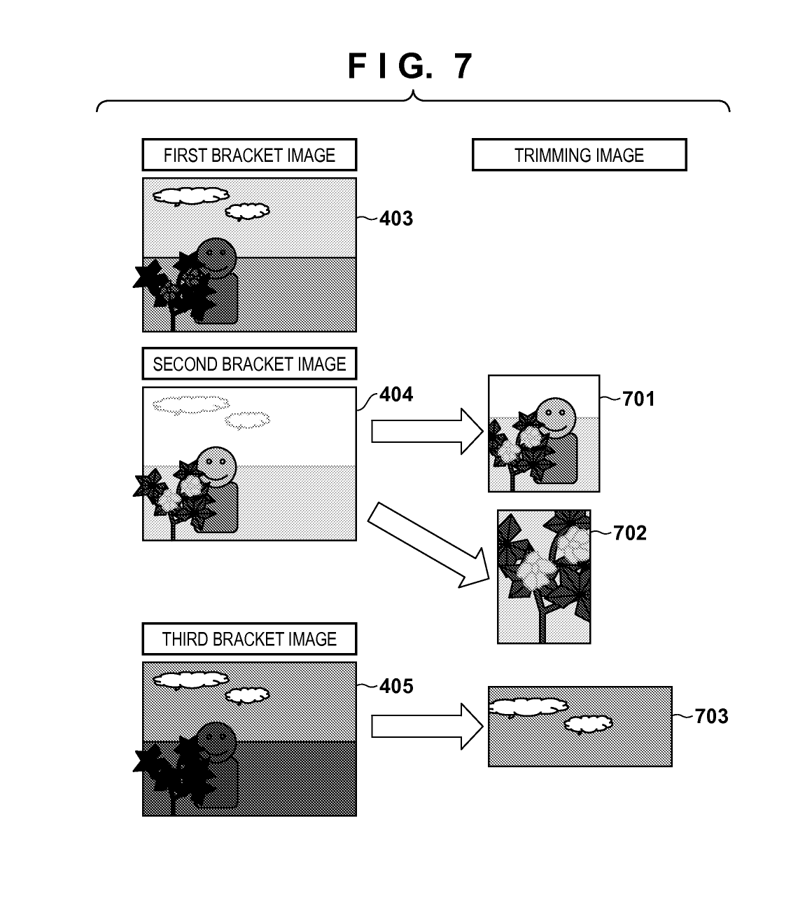

FIG. 7 is a view showing an example of the trimming result of the processing shown in FIG. 6. Images that are to undergo the trimming processing are the second bracket image 404 and the third bracket image 405. No object is trimmed from the first bracket image 403. On the other hand, a trimming image 701 of the object A and a trimming image 702 of the object B are generated from the bracket image 404 in accordance with the scene analysis integration result. In addition, a trimming image 703 of the object C is generated from the bracket image 405.

As described above, even when the brightness or position of an object changes during the time from shooting standby to actual shooting, a bracket image in which the target object has an appropriate exposure can be discriminated by integrating scene analysis results using shot images. For this reason, since image processing can be performed based on appropriate object information from the bracket image, a satisfactory processed image can be generated.

The embodiment of the present invention has been described above. However, the present invention is not limited to the embodiment, and various changes and modifications can be made within the spirit and scope of the present invention. For example, various kinds of parameter values exemplified in the embodiment may be changed to desired values according to the embodiment within the spirit and scope of the present invention. For example, in this embodiment, the number of times of bracket shooting is set as many as the number of objects detected in scene analysis. However, any desired number of times can be set according to the embodiment. A predetermined fixed number of times or a number of times selectable by the user may be set.

In this embodiment, AE bracket has been exemplified. However, the present invention is not exclusively applied to AE bracket and can be applied to any other bracket shooting method. As the basic technical idea of the present invention, a plurality of bracket images are acquired by bracket shooting performed while giving different shooting conditions to objects detected from an image obtained during shooting standby. After that, scene analysis is performed again for each bracket image to newly detect the objects, and it is determined whether the image of a detected object region is an appropriate image. For a bracket image including an appropriate object region, image processing for the object region is performed. The shooting condition that changes between the objects can include not only the exposure condition but also a condition concerning a focus position, a condition concerning the intensity of flash light, and a condition concerning the ISO speed. The flash light and the ISO speed are shooting conditions associated with the luminance of a shot image. For this reason, an appropriate image can be determined based on the luminance value, like, for example, the exposure condition. The focus position will be described below in detail.

For example, AF bracket shooting of shooting images by setting different focus positions for a plurality of objects existing in a scene will be described here. In AF bracket, each of objects having different distances is set as an AF bracket target object, and bracket shooting is performed. The images shot by bracketing are stored in association with an AF bracket target object in focus. After that, predetermined image processing for an associated target object is performed on each image shot by bracketing to generate an image. However, when the object moves during the time from shooting standby to bracket shooting, an image in which the associated target object is out of focus may be generated as an image shot by bracketing. In the present invention, however, in step S303, the sharpness of each pixel value of the object region is measured in each bracket image, and a bracket image having the highest sharpness can be selected again as a bracket image corresponding to the target object.

Note that the sharpness determination can be done by, for example, comparing the average intensity of high-frequency components obtained from the pixel values of the object region. However, any other known method may be used. This makes it possible to reselect a bracket image appropriate for the target object and generate a processed image based on the target object even when the environment or state of the object changes at the time of bracket shooting. As described above, even in the example of AF bracket, a satisfactory processed image can be acquired.

Image processing has been described using a color filter as an example. Alternatively, for example, background blur processing may be used. In the background blur processing, blur processing may be performed for a region (to be referred to as a background region) that is not included in an object region. At this time, in the present invention, even when the scene changes during the time from shooting standby to the actual shooting, the background region can be shaded off so as not to cause a position shift.

Additionally, in the color filter processing, a vignetting filter that yields an effect of darkening the peripheral region of an image may be applied only when the processing region of the vignetting filter has a positional relationship not to overlap the object region. As the vignetting filter, for example, various known methods such as arithmetic processing of lowering the luminance value as the distance from the center of the image increases are usable. When the vignetting filter is applied only when the processing region of the vignetting filter has a positional relationship not to overlap the object region, an effect of preventing an inconvenient image including a dark object region from being generated can be obtained.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-255373, filed Dec. 10, 2013, which is hereby incorporated by reference herein in its entirety.

What is claimed is:

1. An image capturing apparatus comprising:
a shooting unit;
an analysis unit configured to analyze an image shot by said shooting unit; and
an image processing unit configured to process the image based on an analysis result of said analysis unit,
wherein said analysis unit is further configured to analyze a standby image generated by said shooting unit during shooting standby before an instruction of shooting to detect an object from the standby image, and said shooting unit is configured to perform bracket shooting for the detected object using a shooting condition set for each object in accordance with the instruction of shooting,
said analysis unit is further configured to analyze a plurality of bracket images generated by the bracket shooting, to detect an object region including the object from each of the plurality of bracket images, to perform determination for each detected object region in association with the shooting condition, and to select at least one bracket image out of the plurality of bracket images for each object region in accordance with a result of the determination, and
said image processing unit is further configured to execute image processing on the selected bracket image for each object region.

2. The apparatus according to claim 1, wherein the shooting condition is one of an exposure condition, a condition concerning an intensity of flash light, and a condition concerning an ISO speed, and
based on a difference between a predetermined value and a luminance value of each object region, said analysis unit is further configured to select a bracket image including the object region having the smallest difference as the at least one image.

3. The apparatus according to claim 1, wherein the shooting condition is a condition concerning a focus position, and
based on a sharpness of a pixel included in the object region, said analysis unit is further configured to select a bracket image including the object region having the highest sharpness as the at least one image.

4. The apparatus according to claim 1, wherein said image processing unit is further configured to perform, from the at least one bracket image, trimming processing on the object associated with the bracket image.

5. The apparatus according to claim 1, wherein upon determining that a shooting environment does not change between the at least plurality of bracket images, said analysis unit is further configured to select the at least one bracket image from the plurality of bracket images.

6. The apparatus according to claim 5, wherein when satisfying, for the same object detected in each of the plurality of bracket images, at least one of conditions:
a moving amount of the object does not exceed a predetermined moving amount,
a change amount of an angle of view in the plurality of bracket images does not exceed a predetermined change amount, and
a change amount of a luminance value does not exceed a predetermined luminance change amount between the plurality of bracket images, said analysis unit determines that the shooting environment does not change between the plurality of bracket images.

7. The apparatus according to claim 1, wherein the image processing includes color filter processing using a filter according to a type of the object included in the object region.

8. The apparatus according to claim 1, wherein said shooting unit is further configured to perform the bracket shooting as many times as the number of objects detected from the standby image or a predetermined number of times.

9. A control method of an image capturing apparatus including a shooting unit, an analysis unit configured to analyze an image shot by the shooting unit, and an image processing unit configured to process the image based on an analysis result of the analysis unit, the method comprising steps of:
causing the analysis unit to analyze a standby image generated by the shooting unit during shooting standby before an instruction of shooting and detect an object from the standby image;
causing the shooting unit to perform bracket shooting using a shooting condition set for each detected object in accordance with the instruction of shooting;
causing the analysis unit to analyze a plurality of bracket images generated by the bracket shooting and detect an object region including the object from each of the plurality of bracket images;
causing the analysis unit to perform determination for each detected object region in association with the shooting condition and select at least one bracket image out of the plurality of bracket images for each object region in accordance with a result of the determination; and
causing the image processing unit to execute image processing on the selected bracket image for each object region.

10. A non-transitory computer readable storage medium which stores a program for controlling an image capturing apparatus including a shooting unit, an analysis unit configured to analyze an image shot by the shooting unit, and an image processing unit configured to process the image based on an analysis result of the analysis unit, the program being executed to
cause the analysis unit to analyze a standby image generated by the shooting unit during shooting standby before an instruction of shooting and detect an object from the standby image;
cause the shooting unit to perform bracket shooting using a shooting condition set for each detected object in accordance with the instruction of shooting;
cause the analysis unit to analyze a plurality of bracket images generated by the bracket shooting and detect an object region including the object from each of the plurality of bracket images;
cause the analysis unit to perform determination for each detected object region in association with the shooting condition and select at least one bracket image out of the plurality of bracket images for each object region in accordance with a result of the determination; and
cause the image processing unit to execute image processing on the selected bracket image for each object region.
